(19) United States
(12) Patent Application Publication
(10) Pub. No.: US 2009/0210105 A1
(43) Pub. Date: Aug. 20, 2009

(54) AIR-GROUND DETECTION SYSTEM AND METHOD

(76) Inventors: Brock D. Lusby, Everett, WA (US); Todd B. Brouwer, Duvall, WA (US); Thanh-Ha N. Herter, Edmonds, WA (US)

Correspondence Address: MOORE AND VAN ALLEN PLLC FOR BOEING, 430 DAVIS DRIVE, SUITE 500, MORRISVILLE, NC, 27560, US

(21) Appl. No.: 11/383,263

(22) Filed: May 15, 2006

(51) Int. Cl. G06F 19/00; G01L 1/00; G01C 25/00

(52) U.S. Cl. 701/15; 73/862.541; 73/1.78; 701/16

(57) ABSTRACT

A method to detect if an aircraft is airborne or on the ground may include detecting at least one of a truck tilt of each main landing gear and a strut compression of each main landing gear. The method may also include detecting the aircraft being airborne or substantially on the ground in response to at least one of the truck tilt of each main landing gear and the strut compression of each main landing gear.

### BACKGROUND OF THE INVENTION

The present invention relates to aircraft or aerospace vehicle control systems and more particularly to an air-ground detection system and method for controlling operation of an aircraft, aerospace vehicle or the like.

Detecting whether an aircraft is airborne or on the ground or just touching down in a landing can be important to control of the aircraft, such as operation of braking systems or other important aircraft systems during such transitions. An air-ground detection system should be highly reliable and fast acting. For example, faster deployment of speed brakes or other aircraft braking systems upon touchdown may significantly reduce runway rollout length, minimize use of landing gear brakes and hard application of these brakes, and minimize excessive tire wear from excessive, hard braking and the like. Some known systems depend on input from a nose landing gear which requires the airplane to de-rotate or require weight on the wheels for automatic operation of systems, such as speed brake systems or the like. This may delay deployment of such systems resulting in significant runway rollout and excessive use of brakes on the aircraft landing gear. While fast or rapid deployment of speed brakes and other aircraft systems may be important, these systems should only operate when appropriate. Accordingly, checks should be built into the system to prevent inappropriate or incorrect deployment and to alert the pilot if the system or part of the system may not be fully functional or may not operate as expected. Additionally, means should be provided to simulate operation of such systems for maintenance purposes or other purposes.

### BRIEF SUMMARY OF THE INVENTION

In accordance with an embodiment of the present invention, a method to detect if an aircraft is airborne or on the ground may include detecting at least one of a truck tilt of each main landing gear and a strut compression of each main landing gear. The method may also include detecting the aircraft being airborne or substantially on the ground in response to at least one of the truck tilt of each main landing gear and the strut compression of each main landing gear.

In accordance with another embodiment of the present invention, a method to detect if an aircraft is airborne or on the ground may include detecting a truck tilt of each main landing gear to provide a fast on ground signal. The method may also include detecting a strut compression of each main landing gear to provide a sensed slow one side on ground signal. The method may further include detecting an aircraft being airborne or substantially on the ground in response to at least one of the fast on ground signal and the sensed slow one side on ground signal.

In accordance with another embodiment of the present invention, a system to detect if an aircraft is airborne or on the ground may include truck tilt logic to determine a truck tilt of each main landing gear. The system may also include strut compressed logic to determine a strut compression of each main landing gear.

In accordance with another embodiment of the present invention, an aircraft may include left and right main landing gear. The aircraft may also include a system to detect if the aircraft is airborne or on the ground. The system to detect if the aircraft is airborne or on the ground may include tilt logic to determine a truck tilt of each main landing gear. The system may also include strut compressed logic to determine a strut compression of each main landing gear.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

FIG. 1 is a side elevation view of an example of an aircraft including an air-ground detection system in accordance with an embodiment of the present invention.

FIGS. 2A, 2B, 2C and 2D (collectively FIG. 2) are a flow chart of an example of a method for air-ground detection in accordance with an embodiment of the present invention.

FIGS. 3A and 3B (collectively FIG. 3) are an example a system for air-ground detection in accordance with another embodiment of the present invention.

FIG. 4 is an example of a debounce logic circuit in accordance with an embodiment of the present invention.

FIG. 5 is an example of a maintenance override logic circuit in accordance with an embodiment of the present invention.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

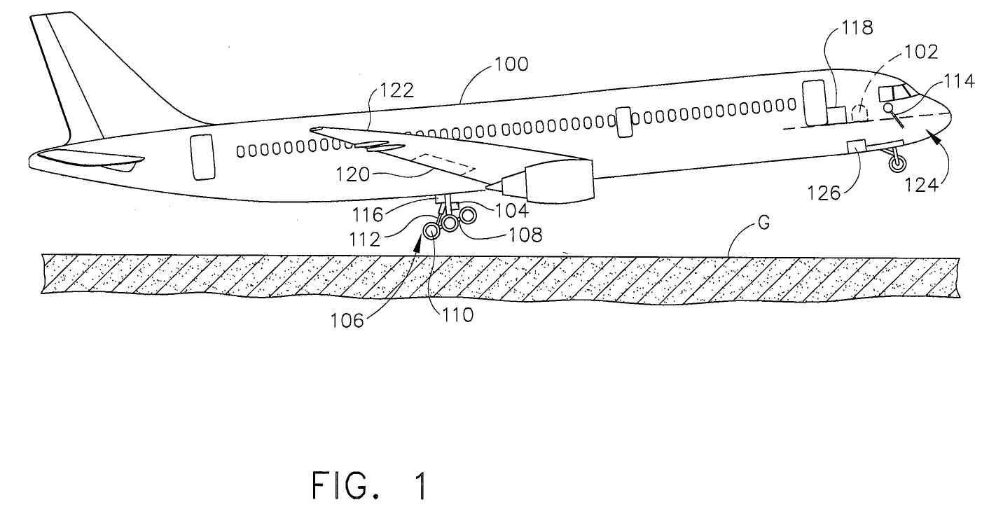

FIG. 1 is a side elevation view of an example of an aircraft 100 including an air-ground detection system 102 in accordance with an embodiment of the present invention. The air-ground detection system 102 may also include at least one truck tilt sensor 104 associated with each main landing gear 106. There may be multiple truck tilt sensors on each main landing gear 106 for redundancy. The aircraft 100 may have a left and right main landing gear 106. Each main landing gear 106 may include a truck 108 or frame to which the wheels 110 of the landing gear 106 are rotatably mounted. The truck tilt sensor 104 or sensors may detect the truck 108 being at a predetermined tilt or angle relative to a strut 112 of the landing gear 106 when the aircraft is airborne and/or may sense or detect the truck untilting from this position when the aircraft 100 touches down or lands. Raising and lowering of the landing gear 106 may be controlled by a pilot from the cockpit by a gear handle 114 that may be moved between a landing gear up position and a landing gear down position.

The air-ground detection system 102 may also include at least one strut compressed or compression sensor 116 associated with each main landing gear 106. There may also be multiple strut compressed sensors 116 associated with each main landing gear for redundancy. The strut compressed sensor 116 may detect or sense the strut 112 of each main landing gear 106 being compressed from a substantially fully extended position when the aircraft 100 is airborne to a compressed position upon landing and weight of the aircraft being applied to the landing gear 106. The truck tilt sensors 104 and strut compressed sensors 116 may each include a switch, proximity sensor, proximity sensor data concentrator (PSDC) or the like. The sensors 104 and 116 may detect or sense that the truck 108 and strut 112 are in the proper positions when the aircraft 100 is airborne and may detect or sense that the aircraft 100 is on the ground (G) or has landed or touchdown when at least one of a truck untilt condition or a strut compressed condition is detected or sensed as described in more detail below.

The air-ground detection system 102 may be coupled to a flight control system (FCS) 118 or the like. The FCS 118 may be a computer system or group of computer systems that coordinate overall control of the aircraft 100 and interface with a pilot via the flight controls and other aircraft systems. As will be described in more detail, the air-ground detection system 102 may be used to automatically arm and deploy speed brakes 120 or the like, or control operation of other aircraft systems associated with takeoffs and landings or similar flight transitions. The speed brakes 120 are typically mounted on top of the wing 122 and are shown in phantom in FIG. 1.

The air-ground detection system 102 may be accessed or controlled via various locations or access points, such as access points 124 and 126 for maintenance purposes as described herein. The aircraft manufacturer may use one access location, such as access point or location 124, for connection of automated test equipment (ATE) or the like to test the air-ground detection system 102 as well as other systems before an aircraft is delivered to a customer, in the field, or if an aircraft is returned to the manufacturer for some reason. The other locations or access points, such as access point 126, may be used by ground crew or airline maintenance personnel to simulate certain conditions for regular or routine maintenance, troubleshooting or other purposes. In other maintenance situations, the aircraft 100 may be mounted on jacks and one or the other access locations 124 and 126 may be used to override the system 102 to simulate airborne and on ground conditions or configuration.

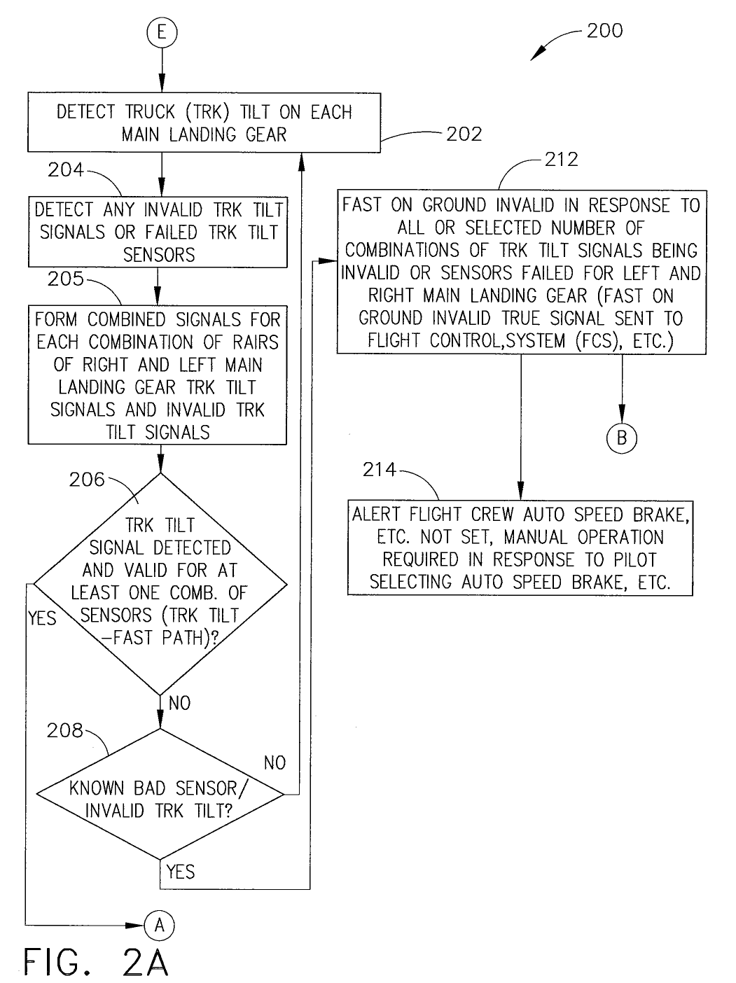

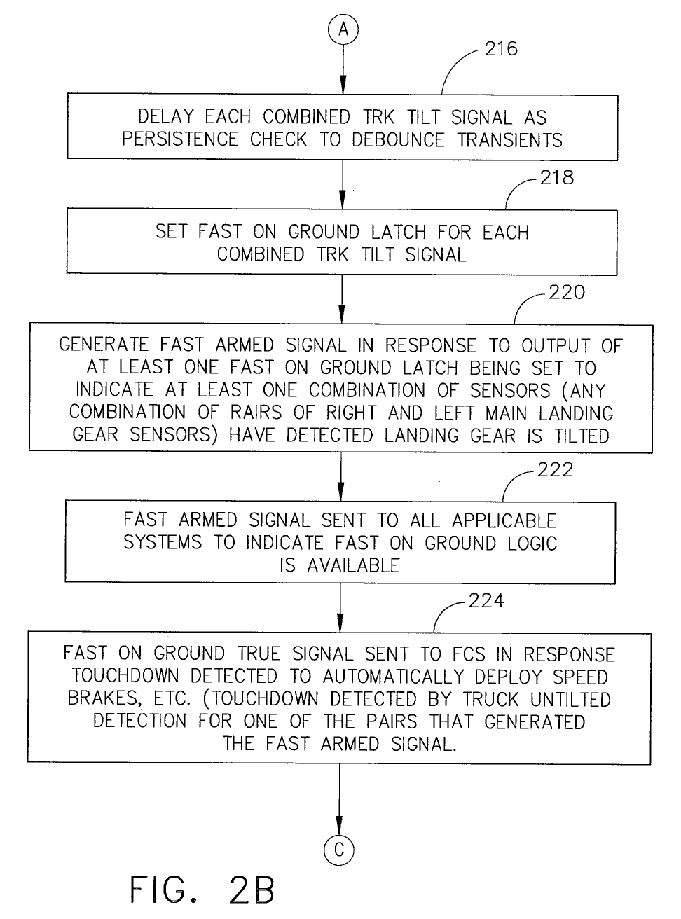

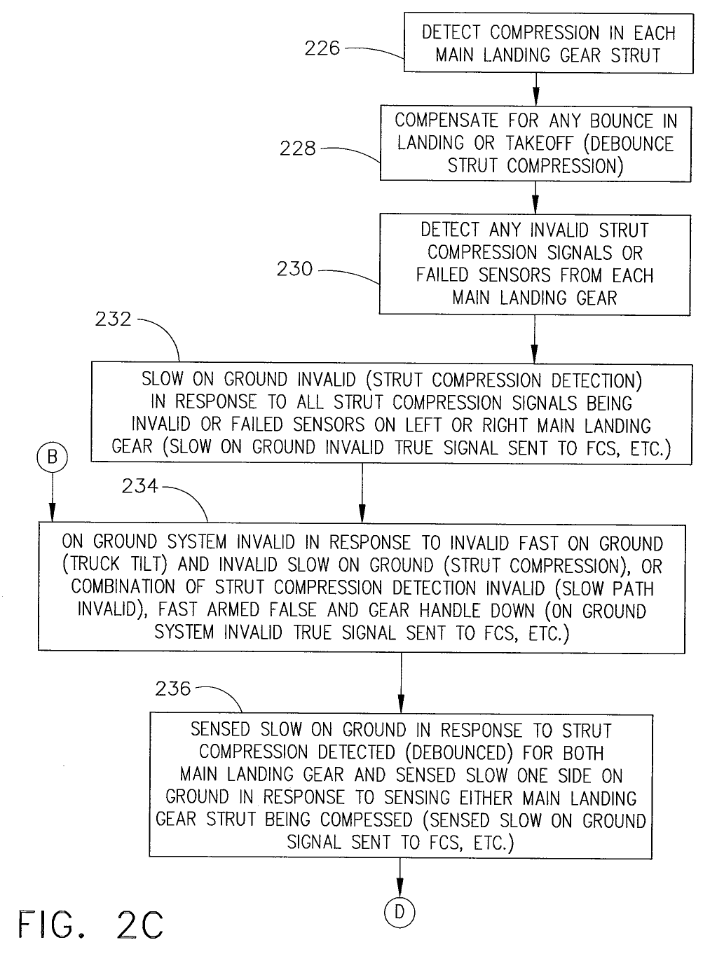

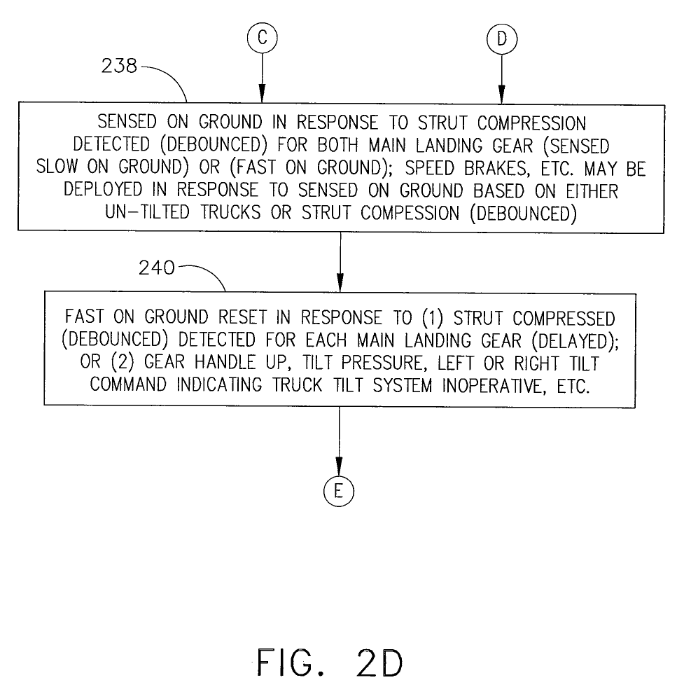

FIGS. 2A, 2B, 2C and 2D (collectively FIG. 2) are a flow chart of an example of a method 200 for air-ground detection in accordance with an embodiment of the present invention. The method 200 may be embodied in the air-ground detection system 102 of FIG. 1. In block 202, truck tilt on each main landing gear may be detected. A signal from a truck tilt sensor indicating that the truck is tilted may be delayed a predetermined time period as a persistence check to prevent any transient signals being sent through the system. The truck tilt path or means for air-ground detection may be defined or characterized as the fast path, fast trigger or fast on ground indication or detection means because flight controls, such as speed brakes or the like, may be rapidly deployed upon aircraft touchdown if all conditions are satisfied as described herein.

In block 204, any invalid truck tilt signals or any truck tilt sensor failures may be detected or determined. In block 205, combined signals may be formed for signals from each combination of pairs of right and left main landing gear truck tilt sensors and invalid truck tilt signals. In block 206, a determination may be made if each of the combination of truck tilt signals are valid. If the determination is made in block 206 that at least one of the combinations of right and left main landing gear truck tilt signals is valid, the fast on ground path may be deemed to be valid and useable for automatically deploying certain aircraft systems such a speed brakes. The method 200 may advance to block 216. If all of the combinations of truck tilt signals are invalid, the fast on ground path is invalid and a fast on ground invalid signal may be generated. If there is not a valid combination of truck tilt signals from sensors associated with each of the right main landing gear and the left main landing gear, the method 200 may advance to block 208.

In block 208, a determination may be made if there is a known invalid truck tilt signal or a known bad sensor. If the determination is no in block 208, the method 200 may return to block 202 and continue monitoring the status of each tilt sensor. If there is a known invalid truck tilt or known bad sensor, the method 200 may advance to block 212.

In block 212, the fast on ground (truck tilt) means of air-ground detection may be invalidated for use or application in automatically deploying or operating an aircraft system, flight controls or the like in response to all or a selected number of combinations of truck tilt signals being invalid or sensors failed for either the left or right main landing gear. A fast on ground invalid true signal may be sent to the flight control system (FCS) or the like.

In block 214, the flight crew may be alerted that automatic operation of predetermined aircraft systems may not be available, such as deployment of the speed brakes or other controls, and such system may need to be manually operated. The alert may be presented or displayed in response to the flight crew selecting automatic speed brake deployment or other control function prior to landing. The method 200 may also advance from block 212 to block 234 which will be described in more detail below.

In block 216, each combined truck tilt signal may be delayed a predetermined time period as a persistence check to debounce the signals to avoid any transient or false signals that may result from the aircraft bouncing or from other causes. In block 218, a fast on ground latch, fast armed latch or the like for each combination of a right and left main landing gear truck tilt sensors may be set in response to each combination of right and left truck tilt signals from the corresponding sensors indicating that the truck is in a tilted position and the signals are valid.

In block 220, a fast armed true signal may be generated in response to an output of at least one fast on ground latch or fast armed latch or the like being set to indicate at least one combination of a right main landing gear sensor and left main landing sensor having detected the main landing gear is in a tilted position. In block 222, the fast armed true signal may be sent to the FCS or all applicable systems to indicate that the fast on ground logic path or truck tilt logic is available for automatic operations of the systems.

In block 224, a fast on ground true signal or the like may be sent to the FCS in response to touchdown being detected to automatically deploy the speed brakes or other flight controls. The fast on ground path or means may involve detecting the landing gear truck being untilted and the fast armed latch being set (fast armed true signal) for any combination of a left main landing gear truck tilt sensor and a right main landing truck tilt sensor. In other words, the fast on ground signal to operate an aircraft system may be generated in response to at least one fast armed latch or the like being set by a combination of a left main landing gear truck tilt sensor and a right main landing gear truck tilt sensor indicating a truck tilted position, and at least the same combination of the left main landing gear truck tilt truck tilt sensor and the right main landing gear truck tilt sensor indicating a truck untilted position. The system may also check that the signals are valid.

In block 226, compression may be detected in each main landing gear strut. The strut compression path or means of air-ground detection may be defined or characterized as the slow path or slow on ground indication or detection means because flight controls, such as speed brakes or the like, may be deployed at a later time upon aircraft touchdown relative to the fast on ground or truck untilt detection path or means.

In block 228, any bounce of the aircraft in landing or takeoff may be compensated by debouncing the strut compression signal or indication. In block 230, any invalid strut compression signals or failed or faulty strut compression sensors from each main landing gear may be detected or determined.

In block 232, the slow on ground path or strut compression detection means may be invalidated, inactivated or inhibited in response to all strut compression signals being invalid or sensors on all landing gear failing or being faulty, or in another embodiment of the present invention, a predetermined number of signals being invalid or sensors faulty. A slow on ground invalid true signal may be sent to the FCS or the like to indicate that the slow on ground or strut compression detection path is invalid and inhibited or not being used with respect to air-ground detection for automatic deployment of flight controls, such as speed brakes or the like.

In block 234, the air-ground detection system or at least on ground detection portion of the system including both truck untilt and strut compression paths or means may be invalidated, inactivated or not used in response to an invalid fast on ground (truck tilt) detection path or means and an invalid slow on ground (strut compression) detection path or means. An on ground system invalid true signal may be sent to the FCS to inhibit or inactivate use of the air-ground detection system for automatic deployment of flight controls. An alert may be sent to the flight crew advising that such system is invalid or inoperative and that manual operation may be necessary or other measures are to be taken.

If the slow on ground system is not invalid in block 232, in block 236, slow on ground may be sensed or detected in response to strut compression for both main landing gear. A sensed slow one side on ground signal may be generated in response to sensing either the right or left main landing gear strut being compressed. The strut compression detection may be debounced or corrected for any aircraft bounce associated with landing or takeoff. A sensed slow on ground true signal or sensed slow one side on ground true signal may be sent to the FCS for any automatic operation of flight controls or other systems.

In block 238, if both the fast on ground and slow on ground paths or detection means are valid, on ground may be sensed in response to truck untilt being detected for any combination of left and right main landing gear trucks (fast trigger (untilt)) and strut compression (debounced) detected for both main landing gear (sensed slow on ground) or either main landing gear (sensed slow one side on ground). A sensed on ground signal may be sent to the FCS for use for deployment of speed brakes or other flight controls. As evident from the preceding, speed brakes or other flight controls may be deployed in response to either the fast on ground path or means (truck untilt), the slow on ground path or means (strut compression) or a combination of both. The signals generated from the different paths or means may be used by the FCS for different purposes and timing of different operations.

In block 240, a fast on ground reset may be generated. The fast on ground reset signal may be generated to reset the fast on ground path (truck tilt path or logic) or each of the fast armed latches. The fast on ground reset signal may be sent to the FCS to deactivate or inhibit the truck tilt detection logic for air-ground detection and subsequent operation of flight controls or other aircraft systems.

The fast on ground reset signal may be generated in response to a number of different conditions. For example the fast on ground reset signal may be generated in response to detecting the strut being compressed (may be corrected for any aircraft bounce) for each main landing gear indicating the aircraft in on the ground; a landing gear handle up indication; a truck tilt pressure being above a predetermined level; or a left or right landing gear truck tilt command (Cmd) signal indicating that the truck tilt system is inoperative. A combined strut compressed signal for both main landing gear may be delayed a predetermined time period for persistence to debounce the signal for any bounce of the aircraft or other transients.

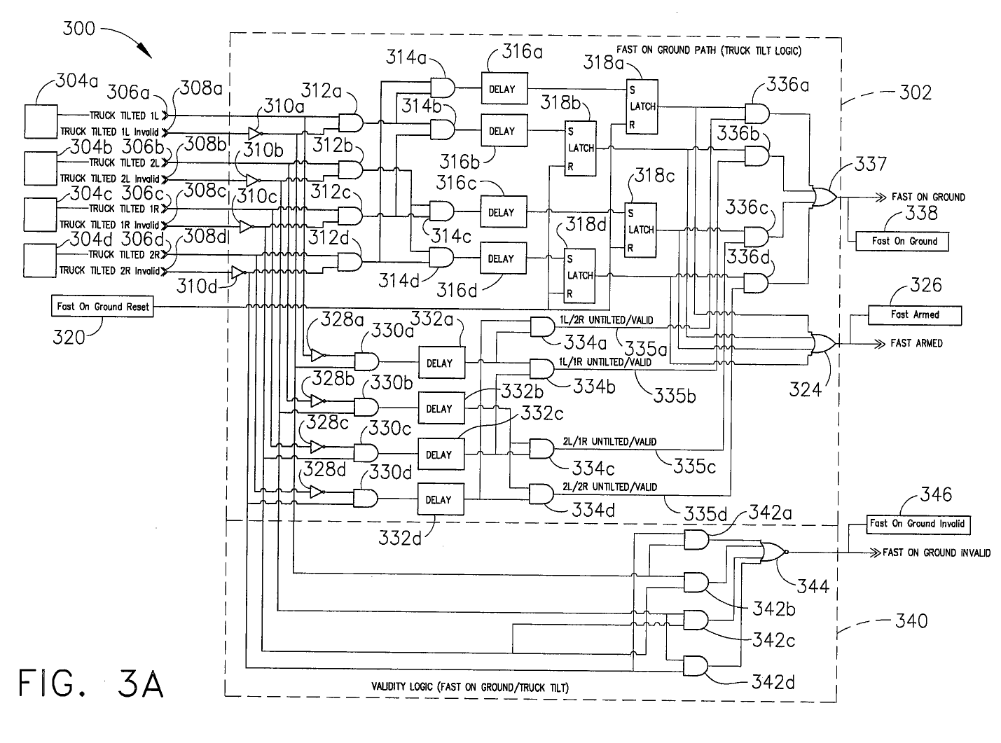

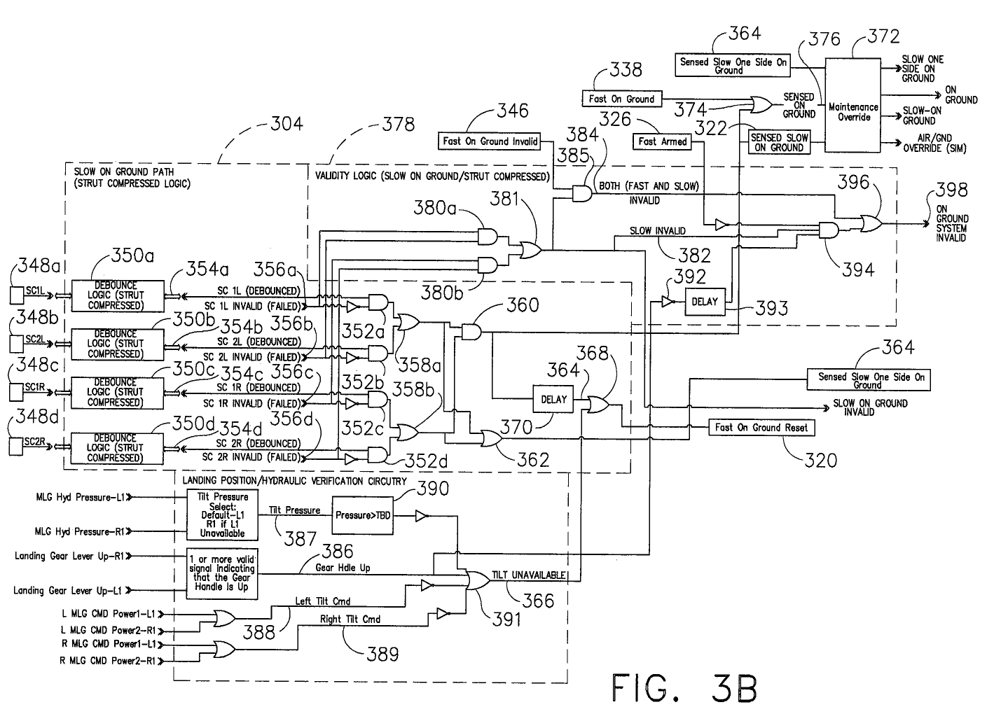

FIGS. 3A and 3B (collectively FIG. 3) are an example a system 300 for air-ground detection in accordance with another embodiment of the present invention. The air-ground detection system 300 may include a Fast On Ground Path or Truck Tilt detection logic 302 (FIG. 3A) and a strut compression or slow on ground detection portion. 304 (FIG. 3B). The Truck Tilt detection portion 302 may be defined or characterized as the fast path, fast trigger or fast on ground detection portion or means because flight controls, such as speed brakes or the like, may be rapidly deployed upon aircraft touchdown if all conditions are satisfied as described herein. The strut compression detection portion 304 may be defined or characterized as the slow path or slow on ground indication or detection portion because flight controls, such as speed brakes or the like, may be deployed less rapidly upon aircraft touchdown relative to the fast on ground or truck untilt detection path or means because aircraft touchdown or on ground may not be detected by strut compression as quickly as truck untilt.

The truck tilt or fast on ground detection portion 302 may include a plurality of truck tilt sensors 304. The truck tilt sensors 304 may be similar to the sensors 104 described with reference to FIG. 1. There may be at least two truck tilt sensors 304 associated with each main landing gear to generate respective truck tilted signals 306, TRUCK TILTED 1L signal 306a and TRUCK TILTED 2L signal 306b from the left main landing gear sensors 304a and 304b, and TRUCK TILTED 1R signal 306c and TRUCK TILTED 2R signal 306d signal from the right main landing gear sensors 304c and 304d. The left and right main landing gear may each be similar to landing gear 106 illustrated in FIG. 1.

Each of the truck tilt sensors 304 may generate a true signal corresponding to the aircraft being airborne with the landing gear being substantially completely down. In this configuration, the landing gear truck should be tilted such that the truck tilt sensors or proximity sensors 304 are in a target near relationship to generate the true signal. Each of the truck tilt sensors 304 may generate a false signal in response to the associated truck being untilted. This may correspond to the aircraft being on the ground or in a configuration other than the landing gear being down and the truck titled to provide the true signal. The truck tilt or proximity sensors 304 in the untilted truck configuration are in a target far relationship and therefore generate the false signal.

A TRUCK TILTED INVALID signal 308 may also be derived or determined from each of the sensors 304. Each of the TRUCK TILTED Invalid signal 308 may be inverted by an inverter 310. The TRUCK TILTED signal 306 and inverted TRUCK TILTED INVALID signal 308 from each sensor 304 may be combined respectively in a first set of AND gates 312. The combined TRUCK TILTED signal 306a/b and inverted INVALIDITY signal 308a/b or VALIDITY signal from each left main landing gear sensor 304a and 304b may be combined with each TRUCK TITLED signal 306c/d and inverted INVALIDITY (or VALIDITY) signal 308c/d from each right main landing gear sensor 304c and 304d in a second set of respective AND gates 314. Accordingly, the logic combines pairs of the combined TRUCK TILTED and VALID signals from two different sensors 304 into the AND gates 314 to produce four different signals representing four possible different pair combinations: 1L and 2R TILTED and VALID signal; 1L and 1R TILTED and VALID signal; 2L and 2R TILTED and VALID signal; and 2L and 2R TILTED and VALID signal. Each of these signals from the AND gates 314 may delayed by a predetermined time period as a persistence check to debounce transients, i.e., the signal momentarily going true. Each signal may be delayed by a 5 second rising edge delay circuit 316 or the like.

The output of each of the four delays 316 may be applied to a SET input of an associated latch 318 or similar device. The latch 318 may be referred to as a fast on ground latch or fast armed latch or the like. A RESET input of each of the four latches 318 may be coupled to a Fast On Ground Reset signal 320 which may derived from either a SENSED SLOW ON GROUND signal 322 (FIG. 3B) being true for a predetermined time period, or other conditions for the trucks to be in a tilted configuration or position being unavailable, such as the landing gear control handle being in an up position, hydraulic pressure being below a predetermined threshold, or other condition, as described in more detail with reference to the Slow On Ground Path 304 below.

The output of each of the latches 318 may represent that a pair of sensors 304 have detected that the landing gear has been tilted. The output of each latch 318 may be applied to a 4-input OR gate 324 to produce a FAST ARMED output signal 326. The FAST ARMED signal 326 may be used to indicate to using systems that the Fast On Ground or Truck Tilt logic is available. An Auto-Speedbrake function, for example, may use this signal or information to determine whether a Fast On Ground signal will be available, or not upon touchdown. If the FAST ARMED signal 326 is False when the Flight Crew attempts to arm the Auto-Speedbrake system, or other systems that may use the Fast On Ground logic, while the aircraft is on approach, a message may be displayed indicating that only manual deployment of the speed brakes or other systems is available.

Each of the TRUCK TILTED signals 306 from the four truck tilt sensors 304 may also be inverted by respective inverters 328 and input into an associated AND gate 330 with each signals corresponding VALIDITY signal (inverted INVALIDITY signal 308) such that the output of each AND gate 330 indicates that the Tilt signal is UNTILTED and VALID. The output signal of each AND gate 330 may be delayed by a predetermined time period as a persistence check to debounce transients. Accordingly, each output signal may be applied to a falling edge delay 332 that may be about a 0.1 second delay. The output signals from each of the delays 332 may then be combined in pairs corresponding to UNTILTED and VALID signals from each combination of left and right main landing gear sensors 304 by a set of AND gates 334 to produce different signals representing the 4 different possible pair combinations from each respective AND gate 334: 1L and 2R UNTILTED and VALID signal 335a; 1L and 1R UNTILTED and VALID signal 335b; 2L and 1R UNTILTED and VALID signal 335c; and 2L and 2R UNTILTED and VALID signal 335d.

The output of each latch 318 represents that a pair of sensors 304 has detected that the landing gear has been tilted (e.g., 1L and 2R TILTED and VALID, etc.). The output of each latch 318 is combined with the corresponding output signal from each untilted/valid AND gate 334 from the same pair of sensors 304 for the landing gear untilting on touchdown (e.g., 1L and 2R UNTILTED and VALID, etc.) by another set of AND gates 336. The output of each of these four AND gates 336 may be applied to a four-input OR gate 337 which may produce an overall FAST ON GROUND signal 338. Accordingly, the FAST ON GROUND signal 338 may result from one of the four possible sensor pair combinations first indicating that the landing gear is tilted on approach, followed by the same sensor pair combination indicating that the landing gear is untilted at touchdown.

The air-ground detection system 300 may also include a Fast On Ground Validity logic portion or module 340 to detect or determine a validity of the Fast On Ground logic 302. The Fast On Ground Validity logic 340 may include a set of AND gates 342 that may respectively receive each combination of left and right main landing gear VALIDITY signals (inverted invalidity signals 308). The output of each AND gate 342 may be applied to a four input NOR gate 344 to produce a FAST ON GROUND INVALID signal 346. Accordingly, if all combinations of validity signals from AND gates 342 indicate an invalid signal, the FAST ON GROUND INVALID signal 346 will be true.

The Fast On Ground or Truck Tilt logic module 302 may confirm the proper truck tilt for the main landing gear based on the truck tilt signals from the sensors 304 being in the proper state and may arm or enable a FCS or the like for the fast on ground deployment of flight controls. As previously discussed, the Truck Tilt detection logic portion 302 of the air-ground detection system 300 may be defined or characterized as the Fast On Ground detection portion or path because the flight controls, such as Auto-Speedbrakes or other systems, may be activated relatively rapidly based on a detected untilted configuration of the landing gear trucks. The tilt logic 302 may actually confirm an on-ground condition based on the truck tilt or rather a truck untilt condition. For this purpose, the tilt logic module 302 may generate the Fast On Ground signal 338. If the Fast On Ground was previously armed or enabled by the Fast Armed signal 326 being true, the Fast On Ground true signal 338 may cause any flight controls, such as speed brakes to be automatically deployed.

The Strut Compression or Slow On Ground detection portion or path 304 may include a plurality of strut compression sensors 348. The strut compression sensors 348 may be similar to the sensors 116 described with reference to FIG. 1. There may be at least two strut compression sensors 348 associated with each main landing gear to generate respective strut compressed (SC) signals, SC 1L and SC 2L from the left main landing gear and SC 1R and SC 2R from the right main landing gear.

The strut compression sensors 348 may generate a false strut compression signal that may correspond to the aircraft being airborne and the landing gear being substantially completely down for landing with the strut fully extended and substantially no compression. In this configuration, the landing gear strut should be substantially fully extended such that the strut compression sensors 348 or proximity sensors are in a target far relationship to generate the false signal. Upon the strut being compressed, a true signal may be generated corresponding to the aircraft being on the ground or in a configuration other than that to provide the false signal as just described. The strut compression or proximity sensors 348 in the strut compressed configuration may be in a target near relationship and therefore generate the true signal.

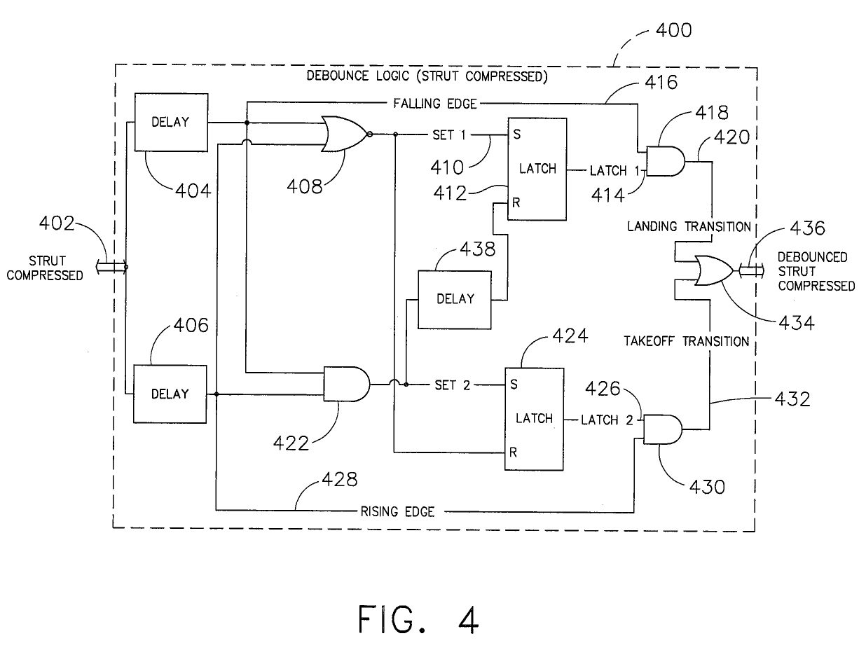

Each strut compressed signal may be compensated for any bounce of the aircraft and false compression of the strut by passing each signal through a debounce logic circuit or module 350. An example of a debounce logic circuit or module is described in more detail with reference to FIG. 4.

The Slow On Ground or Strut Compressed Logic module 304 may include a plurality of strut compressed AND gates 352 depending upon the number of strut compressed sensors 348. A strut compressed AND gate 352 may be associated with each strut compressed sensor 348. Each strut compressed AND gate 352 may receive a strut compressed (SC) debounced signal 354 from the associated strut compressed sensor 348 and an inverted strut compressed invalid (failed) signal 356 from the associated sensor 348. The outputs from the strut compressed AND gates 352 for each main landing gear, right and left, may be applied to a respective OR gate 358. The output from each OR gate 358 may be applied to a sensed slow on ground AND gate 360 to provide a SENSED SLOW ON GROUND signal 322. One or more valid strut compressed signals 354 being from both landing gear will result in a SENSED SLOW ON GROUND true signal 322. The output of each strut compressed OR gate 358 may also be applied to a Slow One Side On Ground OR gate 362 to provide a SENSED SLOW ONE SIDE ON GROUND signal 364.

A delayed Sensed Slow On Ground signal 364 and a Tilt Unavailable signal 366 may be applied to an OR gate 368 to generate the FAST ON GROUND RESET signal 320. An example of generating the Tilt Unavailable signal 366 will be described in more detail below. The SENSED SLOW ON GROUND signal 322 may be delayed by a delay circuit or module 370 a predetermined time duration to generate the delayed Sensed Slow On Ground signal 364 applicable to the OR gate 368. The delay may only occur on a false to true transition or sensing going from airborne to on the ground based on detecting strut compression. No delay may be needed from a true (on ground) to false (airborne) transition. Accordingly, the delay in delay circuit 370 may be a rising edge delay. The output of the OR gate 368 (FAST ON GROUND RESET signal 320) may be applied to each of the Reset inputs of the fast armed latches 318 (FIG. 3A).

The Strut Compressed Logic module 304 may confirm the proper strut compression for each of the main landing gear based on the strut compression signals being in the proper state and may generate the SENSED SLOW ONE SIDE ON GROUND signal 364. A true SENSED SLOW ONE SIDE ON GROUND signal 364 may be fed to the FCS to automatically deploy flight controls, such as speed brakes or the like, if any other required conditions are also satisfied.

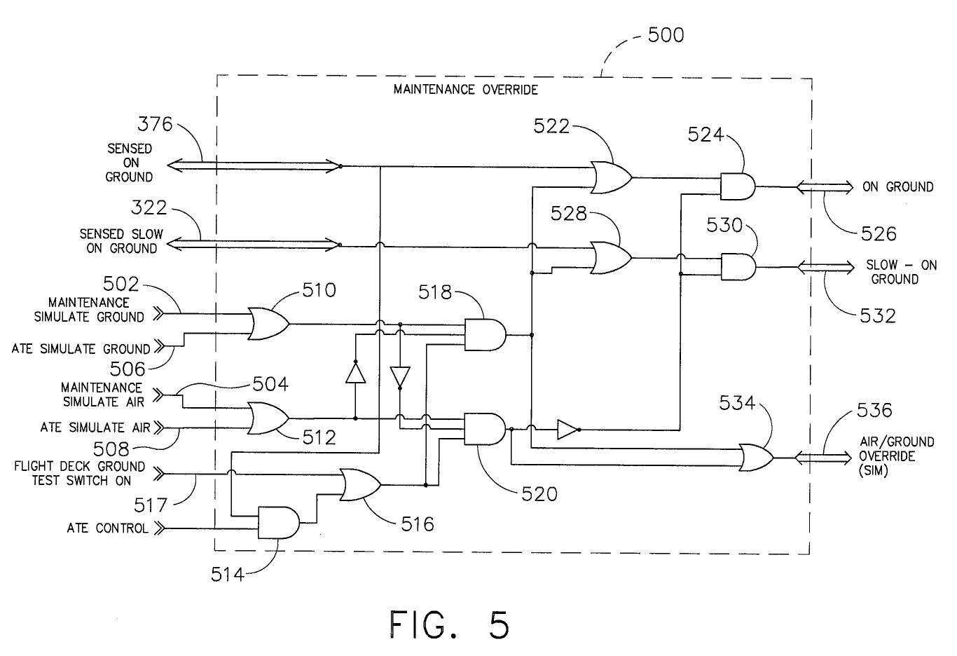

As previously discussed, the Strut Compressed Logic module 304 may also generate a SENSED SLOW ON GROUND signal 322. The SENSED SLOW ON GROUND signal 322 may be transmitted to a Maintenance Override module or circuit 372. An example of a Maintenance Override module or circuit that may be used for circuit 372 will be described in more detail with reference to FIG. 5. The SENSED SLOW ON GROUND signal 322 may also be coupled to an OR gate 374 along with the FAST ON GROUND signal 338 to generate a SENSED ON GROUND signal 376 at the output of the OR gate 374. The SENSED ON GROUND signal 376 may also be transmitted to the Maintenance Override module 372.

The air-ground detection system 300 may also include a Validity Logic circuit or module 378 for the Slow On Ground logic or path 304. The Slow On Ground validity logic circuit or module 378 may determine if the strut compressed signals used by the strut compressed logic 304 are valid or what combination of valid or invalid signals may be reliably used to detect whether the aircraft is airborne or on the ground and whether the signals may be used to automatically deploy certain flight controls. The Validity Logic module 378 may include a left compression or slow path validity AND gate 380a and a right compression or slow path validity AND gate 380b. The left slow path validity AND gate 380a may combine validity signals 1L INVALID 356a and 2L INVALID 356b from each of the left main landing gear compression sensors 348a and 348b. The right slow path validity AND gate 380b may combine validity signals 1R INVALID 356c and 2R INVALID 356d. The combined slow path validity output signals from each slow path validity AND gate 380 may be applied to a slow path validity OR gate 381 to provide a SLOW INVALID signal 382. The SLOW INVALID signal 382 will be true in response to both compression sensors 348 on either main landing gear failing or both compression invalid signals 356 being true or invalid from either main landing gear.

A BOTH (SLOW AND FAST) INVALID signal 384 may be generated by combining the FAST ON GROUND INVALID signal 346 and the SLOW INVALID signal 348 in an AND gate 385. The BOTH (SLOW AND FAST) INVALID signal 384 being true may indicate that both the Truck Tilt (Fast On Ground Path) detection portion 302 and the Strut Compressed (Slow On Ground Path) detection portion 304 of the air-ground detection system 300 are invalid.

The air-ground detection system 300 may also receive other signals from other systems or components. For example a GEAR HANDLE UP signal or indication 386 may be received by the system 300 along with a TRUCK TILT PRESSURE signal (Tilt Pressure) 387 (an indication of the hydraulic pressure for operating the truck tilt feature), a Left Tilt Command (Cmd) signal 388, a Right Tilt Command signal 389 or other signals that may be determinative of whether the aircraft is airborne or on the ground. A determination may be made if the Tilt Pressure exceeds a predetermined pressure in a truck tilt pressure module 390. The output of the truck tilt pressure module 390, LEFT TILT CMD signal 388 and RIGHT TILT CMD signal 389 may be inverted and applied to a Tilt Available OR gate 391 along with the GEAR UP HANDLE signal 386. A true signal for any of the inputs to the OR gate 391 will result in a true TILT UNAVAILABLE output signal 366 indicating that the Truck Tilt detection portion (Fast On Ground Path) 302 is unavailable or not useable for air-ground detection. As previously discussed, the TILT UNAVAILABLE signal 366 may be applied to the OR gate 368 along with the delayed SENSED SLOW ON GROUND signal 364 to provide the FAST ON GROUND RESET signal 320.

The GEAR UP HANDLE signal 386 may also be passed through an inverter 392 and a delay circuit 393 in the Validity Logic module 378. The inverted and delayed GEAR HANDLE UP signal may be applied to an AND gate 394 along with the SLOW INVALID signal 382 and inverted FAST ARMED signal 326. The output of the AND gate 394 and the BOTH (SLOW AND FAST) INVALID signal 384 may be applied to an OR gate 396 to provide an ON GROUND SYSTEM INVALID signal 398. A true ON GROUND SYSTEM INVALID signal 398 represents that neither the Truck Tilt (Fast On Ground Path) detection portion 302 or the Strut Compressed (Slow On Ground Path) detection portion 304 are valid or operable for detecting an on ground transition for automatic operation of flight controls or other systems such a speed brakes.

FIG. 4 is an example of a Debounce Logic circuit 400 in accordance with an embodiment of the present invention. The Debounce Logic circuit 400 may be used for each of the Debounce Strut Compressed Logic circuits 350 in the air-ground detection system 300 (FIG. 3). The incoming strut compressed signal 402 may be applied to respective delay circuits 404 and 406. The first delay 404 may occur on a true to false transition only or when the strut is transitioning from a compressed state (true), such as on the ground, to a non-compressed state (false), such as airborne. There may be no delay from the false to true transition. The second delay 406 may occur from a false transition to a true transition or the opposite of that described above and there may be no delay for the true to false transition. An output of each delay circuit 404 and 406 may be applied to a NOR gate 408 to provide a SET 1 signal 410 to a first latch 412. An output (Latch 1) 414 and a FALLING EDGE signal 416 from the first delay 404 may be applied to a landing transition AND gate 418 to provide a LANDING TRANSITION signal 420.

The output of the first delay 404 and second delay 406 may also be applied to an AND gate 422. The output of the AND gate 422 may provide a SET 2 signal to a second latch 424 to generate a LATCH 2 signal 426. The LATCH 2 signal 426 and a RISING EDGE signal 428 from the second delay 406 may be applied to an AND gate 430 to provide a TAKEOFF TRANSITION signal 432. The LANDING TRANSITION signal 420 and the TAKEOFF TRANSITION signal 432 may be applied to a debounce OR gate 434 to provide a DEBOUNCE STRUT COMPRESSED signal 436.

The SET 1 signal 410 may also be applied to a reset of the second latch 424 and the SET 2 signal may be applied to a reset of the first latch 412 after a predetermined time delay by a delay circuit 438. The delay may occur on the false to true transition and not on the true to false transition similar to that described above. The reset shall over power the set for each latch 412 and 424. Each latch 412 and 424 shall power up in the reset state. Any upset shall cause the latches to reset.

FIG. 5 is an example of a Maintenance Override logic circuit 500 in accordance with an embodiment of the present invention. The Maintenance Override logic circuit 500 may be used for the Maintenance Override circuit or module 372 in FIG. 3B. There may be different types of systems and access points to utilize the Maintenance Override circuit 500 and for multiple different purposes. For example, for regular or routine maintenance, troubleshooting or for other purposes the Maintenance Override circuit 500 may be accessed from a maintenance port or access point, such as access point 124 or 126 in FIG. 1 to provide a MAINTENANCE SIMULATE GROUND signal 502 or a MAINTENANCE SIMULATE AIR signal 504. An example of another system that may access and utilize the Maintenance Override circuit 500 for testing may be Automated Test Equipment (ATE) or the like. An aircraft manufacturer may use ATE in testing an air-ground detection system, such as system 300 in FIG. 3, as well as other aircraft systems before delivery of the aircraft to a customer, for field testing or for other purposes. ATE or similar equipment may generate an ATE SIMULATE GROUND signal 506 or an ATE SIMULATE AIR signal 508.

The Maintenance Override circuit 500 may include a simulate ground OR gate 510 to receive the MAINTENANCE SIMULATE GROUND signal 502 or the ATE SIMULATE GROUND Signal 506 or similar signals. The Maintenance Override circuit 500 may also include a simulate air OR gate 512 to receive the MAINTENANCE SIMULATE AIR signal 504 or the ATE MAINTENANCE SIMULATE AIR signal 508 or similar signals. An ATE control AND gate 514 may receive an ATE CONTROL signal from ATE or similar equipment and may also receive the SENSED ON GROUND signal 376, as also illustrated in FIG. 3B. An ATE OR gate 516 may receive the output of the ATE control AND gate 514 and a FLIGHT DECK GROUND TEST SWITCH ON signal 517.

A simulate ground AND gate 518 may receive the output from the simulate ground OR gate 510, an inverted output from the simulate air OR gate 512 and the output of the ATE OR gate 516. A simulate air AND gate 520 may receive the output from the simulate air OR gate 512, an inverted output from the simulate ground OR gate 510 and the output of the ATE OR gate 516.

A maintenance sensed on ground OR gate 522 may receive the SENSED ON GROUND signal 376 and the output of the simulate ground AND gate 518. A maintenance on ground AND gate 524 may receive the output of the maintenance sensed on ground OR gate 522 and an inverted output from the simulate air AND gate 520 to provide an ON GROUND signal 526.

A maintenance sensed slow on ground OR gate 528 may receive the SENSED SLOW ON GROUND signal 322 (also shown in FIG. 3B) and an output of the simulate on ground AND gate 518. A maintenance slow on ground AND gate 530 may receive the output of the maintenance sensed slow on ground OR gate 528 and the inverted output of the simulate air AND gate 520 to provide a SLOW ON GROUND signal 532.

A maintenance air-ground override (sim) OR gate 534 may receive the output from the simulate on ground AND gate 518 and the simulate air AND gate 520 to provide an AIR/GROUND OVERRIDE (SIM) signal 536.

Truth tables illustrating operation of the maintenance override circuit 500 are shown in Tables 1 and 2 below.

TABLE 1

| | FORCED | | | | A/G |
|---|---|---|---|---|---|
| SNSD | TO | FORCED | MAINT | | OVRRIDE |
| OG | GROUND | TO AIR | SW ON | ON GND | (SIM) |
| FALSE | FALSE | FALSE | FALSE | FALSE | FALSE |
| FALSE | FALSE | FALSE | TRUE | FALSE | FALSE |
| FALSE | FALSE | TRUE | FALSE | FALSE | FALSE |
| FALSE | FALSE | TRUE | TRUE | FALSE | TRUE |
| FALSE | TRUE | FALSE | FALSE | FALSE | FALSE |
| FALSE | TRUE | FALSE | TRUE | TRUE | TRUE |
| FALSE | TRUE | TRUE | FALSE | FALSE | FALSE |
| FALSE | TRUE | TRUE | TRUE | FALSE | FALSE |
| TRUE | FALSE | FALSE | FALSE | TRUE | FALSE |
| TRUE | FALSE | FALSE | TRUE | TRUE | FALSE |
| TRUE | FALSE | TRUE | FALSE | TRUE | FALSE |
| TRUE | FALSE | TRUE | TRUE | FALSE | TRUE |
| TRUE | TRUE | FALSE | FALSE | TRUE | FALSE |
| TRUE | TRUE | FALSE | TRUE | TRUE | TRUE |
| TRUE | TRUE | TRUE | FALSE | TRUE | FALSE |
| TRUE | TRUE | TRUE | TRUE | TRUE | FALSE |

TABLE 2

| SNSD | FORCED | | | | A/G |
|---|---|---|---|---|---|
| SLOW | TO | FORCED | MAINT | SLOW | OVRRIDE |
| OG | GROUND | TO AIR | SW ON | OG | (SIM) |
| FALSE | FALSE | FALSE | FALSE | FALSE | FALSE |
| FALSE | FALSE | FALSE | TRUE | FALSE | FALSE |
| FALSE | FALSE | TRUE | FALSE | FALSE | FALSE |
| FALSE | FALSE | TRUE | TRUE | FALSE | TRUE |
| FALSE | TRUE | FALSE | FALSE | FALSE | FALSE |
| FALSE | TRUE | FALSE | TRUE | TRUE | TRUE |
| FALSE | TRUE | TRUE | FALSE | FALSE | FALSE |
| FALSE | TRUE | TRUE | TRUE | FALSE | FALSE |
| TRUE | FALSE | FALSE | FALSE | TRUE | FALSE |
| TRUE | FALSE | FALSE | TRUE | TRUE | FALSE |
| TRUE | FALSE | TRUE | FALSE | TRUE | FALSE |
| TRUE | FALSE | TRUE | TRUE | FALSE | TRUE |
| TRUE | TRUE | FALSE | FALSE | TRUE | FALSE |
| TRUE | TRUE | FALSE | TRUE | TRUE | TRUE |
| TRUE | TRUE | TRUE | FALSE | TRUE | FALSE |
| TRUE | TRUE | TRUE | TRUE | TRUE | FALSE |

The default values for on ground hosted functions may be 0 for maintenance simulate ground; ATE simulate ground; maintenance simulate air; ATE simulate air; flight deck ground test switch on; and ATE control.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. A method to detect if an aircraft is airborne or on the ground, comprising:
detecting at least one of a truck tilt of each main landing gear and a strut compression of each main landing gear;
detecting the aircraft being airborne or substantially on the ground in response to at least one of the truck tilt of each main landing gear and the strut compression of at least one main landing gear; and
generating a reset signal in response to at least one of the strut compression being detected for each main landing gear, a landing gear handle up indication, a truck tilt pressure being above a predetermined value, or a landing gear truck tilt signal indicating that a truck tilt system is inoperable, the reset signal resetting truck tilt logic to deactivate or inhibit the truck tilt detection.

2. The method of claim 1, further comprising determining whether the detected truck tilt of each main landing gear is valid.

3. The method of claim 1, further comprising compensating for any bounce of the aircraft during takeoff and landing.

4. The method of claim 1, further comprising compensating a truck tilt detection signal for any transients.

5. The method of claim 1, further comprising determining whether the detected strut compression of each main landing gear is valid.

6. The method of claim 1, further comprising compensating a strut compression detection signal for any bounce of the aircraft during takeoff and landing.

7. The method of claim 1, further comprising simulating an on ground condition for maintenance purposes.

8. The method of claim 1, further comprising simulating an airborne condition for maintenance purposes.

9. The method of claim 1, using only the detecting strut compression in detecting the aircraft being airborne or substantially on the ground.

10. The method of claim 1, further comprising:
detecting any truck tilt signals being invalid or truck tilt sensors failing; and
invalidating truck tilt detection in response to a right main landing gear truck tilt signal and a left main landing gear truck tilt signal being invalid or a right main landing gear truck tilt sensor and a left main landing gear truck tilt sensor failing.

11. The method of claim 1, further comprising:
detecting any invalid strut compression signals or strut compression sensors failing; and
invalidating strut compression detection in response to a predetermined number of strut compression signals being invalid for either main landing gear or a predetermined number of strut compression sensors failing for either main landing gear.

12. The method of claim 1, further comprising invalidating an air-ground detection system in response to invalidating truck tilt detection and invalidating strut compression detection.

13. The method of claim 1, further comprising:
detecting the aircraft being airborne in response to detecting each main landing gear truck being tilted; and
detecting the aircraft being on the ground in response to detecting each main landing gear truck being untilted.

14. The method of claim 1, further comprising:
detecting the aircraft being airborne in response to detecting at least one main landing gear strut being uncompressed; and
detecting at least one side of the aircraft being on the ground in response to detecting at least one main landing gear being compressed.

15. The method of claim 1, further comprising detecting the aircraft being on the ground in response to at least one of detecting each main landing gear truck being untilted or each main landing gear strut being compressed.

16. A method to detect if an aircraft is airborne or on the ground, comprising:
detecting a truck tilt of each main landing gear to provide a fast on ground signal;
detecting a strut compression of at least one main landing gear to provide a sensed slow one side on ground signal;
detecting an aircraft being airborne or substantially on the ground in response to at least one of the fast on ground signal and the sensed slow one side on ground signal; and
generating a fast on ground reset signal in response to at least one of the strut compression being detected for each main landing gear, a landing gear handle up indication, a truck tilt pressure being above a predetermined value, or a landing gear truck tilt signal indicating that a truck tilt system is inoperable, the fast on ground reset signal resetting truck tilt logic to deactivate or inhibit the truck tilt detection.

17. The method of claim 16, further comprising generating a fast armed signal for automatic operation of a predetermined aircraft system in response to detecting the truck tilt of each main landing gear being untilted.

18. The method of claim 16, further comprising generating a fast armed signal in response to setting at least one fast armed latch associated with each of a left main landing gear truck tilt sensor and a right main landing gear truck tilt sensor that indicate a truck tilted position.

19. The method of claim 16, further comprising generating a fast on ground signal to operate an aircraft system in response to at least one fast armed latch being set by a combination of a left main landing gear truck tilt sensor and a right main landing gear truck tilt sensor indicating a truck tilted position and in response to detecting at least one fast armed latch being set by a combination of the left main landing gear truck tilt sensor and the right main landing gear truck tilt sensor indicating a truck untilted position.

20. (canceled)

21. The method of claim 16, further comprising:
determining whether a truck tilt signal from a truck tilt sensor is valid; and
determining whether a strut compression signal from a strut compression sensor is valid.

22. The method of claim 16, further comprising invalidating a truck tilt detection path in response to any combination of a right main landing gear truck tilt detection signal and a left main landing gear truck tilt detection signal being invalid or a right main landing gear truck tilt sensor and a left main landing gear truck tilt sensor failing.

23. The method of claim 16, further comprising invalidating a strut compression path in response to a predetermined number of strut compression signals for either main landing gear being invalid or a predetermined number of sensors failing for either main landing gear.

24. The method of claim 16, further comprising detecting an aircraft being airborne in response to at least one of detecting each main landing gear truck being tilted and detecting at least one main landing gear strut being uncompressed.

25. The method of claim 16, further comprising detecting an aircraft being on the ground in response to at least one of detecting each main landing gear truck being untilted or each main landing gear strut being compressed.

26. A system to detect if an aircraft is airborne or on the ground, comprising:
truck tilt logic to determine a truck tilt of a main landing gear and provide a fast on ground signal;
strut compressed logic to determine a strut compression of the main landing gear; and
reset logic to generate a fast on ground reset signal in response to at least one of the strut compression being detected for each main landing gear, a landing gear handle up indication, a truck tilt pressure being above a predetermined value, or a landing gear truck tilt signal indicating that a truck tilt system is inoperable, the fast on ground reset signal resetting the truck tilt logic to deactivate or inhibit truck tilt detection.

27. The system of claim 26, further comprising validity logic to determine a validity of the tilt logic and the strut compressed logic.

28. The system of claim 26, further comprising:
at least one truck tilt sensor associated with each main landing gear; and
at least one strut compression sensor associate with each main landing gear.

29. The system of claim 28, wherein the at least one truck tilt sensor and the at least one strut compressed sensor each comprise one of a switch, a proximity sensor, and a proximity sensor data concentrator.

30. The system of claim 26, further comprising debounce logic to compensate for any bounce of the aircraft during takeoff and landing.

31. The system of claim 26, further comprising a maintenance override to simulate operation of the system in the air and on the ground.

32. The system of claim 26, wherein the tilt logic comprises a fast armed latch for each of a left main landing gear truck tilt signal and a right main landing gear truck tilt signal

33. An aircraft, comprising:
left and right main landing gear;
a system to detect if the aircraft is airborne or on the ground, the system comprising:
tilt logic to determine a truck tilt of each main landing gear and provide a fast on ground signal;
strut compressed logic to determine a strut compression of each main landing gear; and
reset logic to generate a fast on ground reset signal in response to at least one of the strut compression being detected for each main landing gear, a landing gear handle up indication, a truck tilt pressure being above a predetermined value, or a landing gear truck tilt signal indicating that a truck tilt system is inoperable, the reset signal resetting the truck tilt logic to deactivate or inhibit truck tilt detection.

34. The aircraft of claim 33, further comprising validity logic to determine whether signals associated with the tilt logic and the strut compressed logic are valid.

35. The aircraft of claim 33, further comprising:
at least one truck tilt sensor associated with each main landing gear; and
at least one strut compression sensor associate with each main landing gear.

36. The aircraft of claim 33, further comprising debounce logic to compensate for any bounce of the aircraft during takeoff and landing.

37. The aircraft of claim 33, further comprising a maintenance override to simulate operation of the system in the air and on the ground.
